(19) United States
(12) Patent Application Publication
(10) Pub. No.: US 2007/0286266 A1
(43) Pub. Date: Dec. 13, 2007

(54) Sideways-fed transmitter

(76) Inventors: Kenneth W. Paist, Spring City, PA (US); Andy Turudic, Hillsboro, OR (US)

Correspondence Address: MENDELSOHN & ASSOCIATES, P.C., 1500 JOHN F. KENNEDY BLVD., SUITE 405, PHILADELPHIA, PA, 19102, US

(21) Appl. No.: 11/451,075

(22) Filed: Jun. 12, 2006

(51) Int. Cl. H04B 1/38

(52) U.S. Cl. 375/219

(57) ABSTRACT

An apparatus for transmitting and receiving data via a transmission medium. The apparatus includes a local receiver and a local transmitter. The local receiver receives an incoming data signal transmitted through the transmission medium by a remote transmitter and derives from the incoming data signal one or more processing parameters corresponding to one or more characteristics of the transmission medium. The local transmitter receives the one or more processing parameters from the local receiver, generates an outgoing data signal using the one or more processing parameters, and transmits the outgoing data signal through the transmission medium.

### BACKGROUND OF THE INVENTION

1. Field of the Invention

The present invention relates to transmitters, and, in particular, to the equalization of transmitted signals to compensate for impairments in a transmission medium.

2. Description of the Related Art

A typical transmitter originates an electrical or optical signal by launching one or more modulated signals that contain information, through a medium, to a receiver. The receiver then converts the received electrical or optical signal(s) into information. In a typical real-world scenario, the medium suffers from one or more impairments affecting the transmitted signal. Such impairments may include frequency-domain impairments and time-domain impairments, for example, attenuation with distance, attenuation with frequency, phase shift with frequency, phase delays, velocity change with frequency, and, in radio, multipath interference. In receivers, various forms of compensation are employed using analog methods (e.g., filters and amplifiers) or digital methods (typically quantization followed by numerically-processed filtering, such as Decision-Feedback Equalization (DFE) and algorithmic-information recovery). On the transmitter side, some degree of equalization is typically employed by pre-distorting the signal by various means, which may include either analog means (e.g., amplifiers and filters) or digital means (typically pre-distorted, numerically processed, and/or filtered using, e.g., a Finite-Impulse Response (FIR) filter, and then converted to an analog signal).

FIG. 1 illustrates an exemplary prior-art communications system 100 comprising transceivers 101-1 and 101-2, which exchange information with one another through a medium, such as impaired medium 120. Transceiver 101-1 includes a transmitter 102-1 and a receiver 103-1, and transceiver 101-2 includes a transmitter 102-2 and a receiver 103-2.

Transmitter 102-1 includes an encoder 104-1, a FIR filter 105-1, a coefficient register 108-1, a Digital-to-Analog (D/A) converter 106-1, and an amplifier 107-1. Encoder 104-1 receives and encodes digital information and provides the encoded digital information to FIR filter 105-1. FIR filter 105-1 receives from coefficient register 108-1 coefficients that FIR filter 105-1 uses in filtering and pre-distorting the encoded digital information. These coefficients may be statically or dynamically fed to FIR filter 105-1 based upon, e.g., empirical rules or bit-error checking, to modify the characteristics of the signal to permit eventual recovery of the encoded information with the least amount of error. The coefficients may be determined based on prior knowledge of the channel, e.g., component location, type of media, or transmission distance. In certain complex systems, a handshake with second transceiver 101-2 might occur through impaired medium 120 to determine the best setting for the coefficients to provide to FIR filter 105-1. FIR filter 105-1 provides the filtered, pre-distorted encoded information to D/A converter 106-1, which information D/A converter 106-1 converts to an analog signal, providing the analog signal to amplifier 107-1. Amplifier 107-1 amplifies the analog signal to permit travel of the analog signal through impaired medium 120, to be received by receiver 103-2.

In a duplex system, such as system 100, higher performance may be achieved by using an “in-band” or “out-of-band” training (or signaling) sequence. This sequence is used to transmit receiver settings back to the corresponding transmitter, such that the transmitter may adjust its FIR coefficients to improve the received signal. This communications protocol requires either bandwidth overhead, an alternative channel, or a startup period during which no information (other than the training sequence) is transmitted and received by the host systems.

In system 100, transmitter 102-2 is configured similarly to transmitter 102-1, with the amplified analog signal from amplifier 107-2 traveling through impaired medium 120 for receipt by receiver 103-1.

Receiver 103-1 includes a preamplifier 109-1, an analog-to-digital (A/D) converter 110-1, a decision-feedback equalizer (DFE) 111-1, a coefficient calculator 113-1, and a decoder 112-1. Preamplifier 109-1 receives the analog signal from amplifier 107-2 via impaired medium 120 and provides an amplified analog signal to A/D converter 110-1, which provides a digital signal to both DFE 111-1 and coefficient calculator 113-1. In system 100, based on step-response (or alternatively, impulse-response or frequency-response) characteristics of the medium extrapolated or derived from the received digital signal from A/D converter 110-1, coefficient calculator 113-1 generates and provides to DFE 111-1 coefficients that DFE 111-1 uses in equalizing the digital signal.

In system 100, the received data is non-return-to-zero (NRZ) and approximates a step response for long run-length data, i.e., lengthened periods of a high or low state. Accordingly, A/D converter 110-1 includes an equalizer (or comparator or “slicer”) to permit digitization of the step response, so that overshoot, frequency, waveform-ringing, and other step-response characteristics may be captured either over a single event or over a period of time. Capturing this step response numerically permits the computation of a transfer function within receiver 103-1 that restores the step response to a more ideal step, e.g., as disclosed in U.S. Pat. No. 6,675,328 to Krishnamachari et al, incorporated by reference in its entirety herein. This transfer function may also include known impairment differences, such as the presence (or absence) of vias, connectors, stubs, or other impairments in the transmit direction.

In other scenarios, the coefficients for DFE 111-1 may also be derived in other ways (not shown), just as with the coefficients for FIR filter 105-1 of transmitter 102-1. For example, the coefficients may be statically or dynamically fed to DFE 111-1 based upon, e.g., empirical rules or bit-error checking, to modify the characteristics of the signal to permit recovery of the encoded information with the least amount of error. Alternatively, coefficients may be determined, e.g., based on prior knowledge of the channel, e.g., component location, type of media, or transmission distance. In certain complex systems, a handshake with second transceiver 101-1 might occur through impaired medium 120 to determine the best setting for the coefficients to provide to DFE 111-1. Information during the encoding process typically includes an encoding, error-correction, and/or parity-checking scheme, such that errors may be detected in the receiver. The task of DFE 111-1 is to minimize errors, and the error check is sometimes sufficient to determine the optimum coefficients for DFE 111-1. The equalized output of DFE 111-1 is provided to decoder 112-1, which decodes the equalized output and provides decoded digital information.

In system 100, receiver 103-2 is configured similarly to receiver 103-1, with preamplifier 109-2 receiving the amplified analog signal from amplifier 107-1 of transmitter 102-1.

### SUMMARY OF THE INVENTION

Problems in the prior art are addressed in accordance with the principles of the present invention by providing a scheme for setting transmitter FIR coefficients using channel characteristics determined by a receiver at the same site. The disadvantages of using a training sequence can thus be avoided, i.e., the occupation of media bandwidth, the requirement of a functional transmitter and receiver at both ends, and/or the blocking of transmission altogether while the training sequence is being communicated.

In one embodiment, the present invention provides an apparatus for transmitting and receiving data via a transmission medium and comprises a local receiver and a local transmitter. The local receiver is adapted to (1) receive an incoming data signal transmitted through the transmission medium by a remote transmitter and (2) derive from the incoming data signal one or more processing parameters corresponding to one or more characteristics of the transmission medium. The local transmitter is adapted to (1) receive the one or more processing parameters from the local receiver, (2) generate an outgoing data signal using the one or more processing parameters, and (3) transmit the outgoing data signal through the transmission medium.

In another embodiment, the present invention provides a method for transmitting and receiving data via a transmission medium. The method comprises: (a) receiving, by a local receiver, an incoming data signal transmitted through the transmission medium by a remote transmitter; (b) deriving, by the local receiver, from the incoming data signal one or more processing parameters corresponding to one or more characteristics of the transmission medium; (c) transmitting the one or more processing parameters from the local receiver to a local transmitter; (d) generating, by the local transmitter, an outgoing data signal using the one or more processing parameters; and (e) transmitting, by the local transmitter, the outgoing data signal through the transmission medium.

In a further embodiment, the present invention provides an apparatus for transmitting and receiving data via a transmission medium. The apparatus comprises a local receiver and a local transmitter. The local receiver comprises an analog-to-digital (A/D) converter, a coefficient calculator, and a Decision-Feedback Equalizer (DFE). The A/D converter is adapted to generate a digital signal from an incoming data signal. The coefficient calculator is adapted to generate, based on the digital signal, one or more processing parameters corresponding to one or more characteristics of the transmission medium. The DFE is adapted to apply the one or more processing parameters as part of processing of the incoming data signal. The local receiver is adapted to (1) receive an incoming data signal transmitted through the transmission medium by a remote transmitter and (2) derive from the incoming data signal the one or more processing parameters. The local transmitter comprises a Finite-Impulse Response (FIR) filter adapted to apply the one or more processing parameters as part of the generation of an outgoing data signal. The local transmitter is adapted to (1) receive the one or more processing parameters from the local receiver, (2) generate the outgoing data signal using the one or more processing parameters, and (3) transmit the outgoing data signal through the transmission medium.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 illustrates a prior-art communications system comprising a pair of transceivers; and

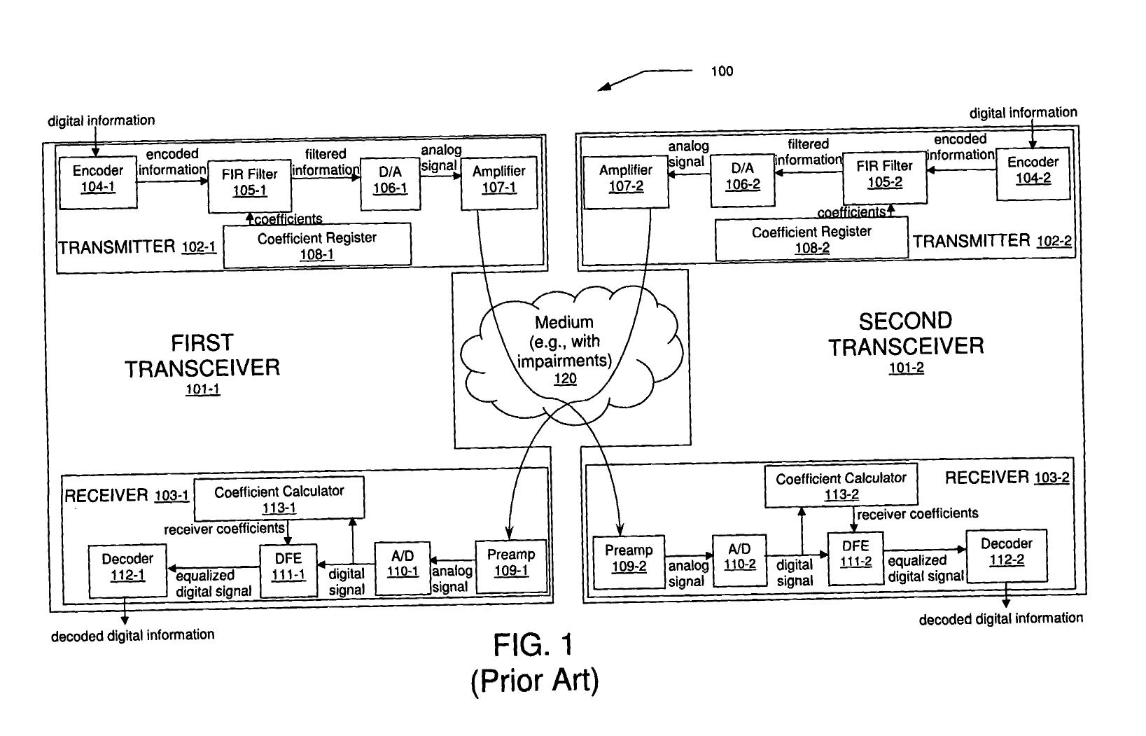

FIG. 2 illustrates an exemplary communications system consistent with one embodiment of the present invention.

### DETAILED DESCRIPTION

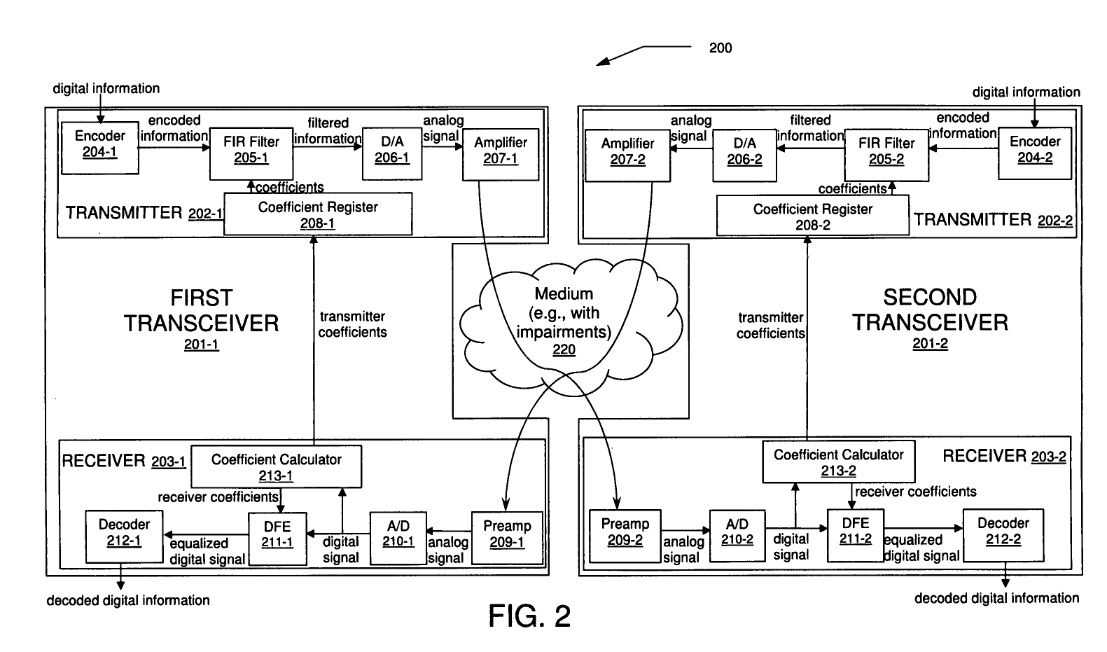

FIG. 2 illustrates an exemplary communications system 200 consistent with one embodiment of the present invention. Communications system 200 comprises transceivers 201-1 and 201-2, which exchange information with one another through a medium, such as impaired medium 220. Transceiver 201-1 includes a transmitter 202-1 and a receiver 203-1, and transceiver 201-2 includes a transmitter 202-2 and a receiver 203-2.

In most real-world implementations, medium 220 will be substantially symmetrical, i.e., the same or at least a similar degree of impairment occurs in a transmission from transmitter 202-1 to receiver 203-2 as in a transmission from transmitter 202-2 to receiver 203-1. Even if medium 220 is not symmetrical, the impairment in a transmission from transmitter 202-1 to receiver 203-2 will at least be correlated or closely correlated to the impairment in a transmission from transmitter 202-2 to receiver 203-1. Accordingly, transceiver 201-1 is adapted to exploit this symmetry or correlation to permit coefficients, which are generated by a coefficient calculator 213-1 of receiver 203-1 based on step-response characteristics extrapolated or derived from the digital signal provided by an analog-to-digital (A/D) converter 210-1 of receiver 203-1, to be used by a coefficient register 208-1 of transmitter 202-1 to set the coefficients for a finite-impulse response (FIR) filter 205-1 of transmitter 202-1.

Transmitter 202-1 includes an encoder 204-1, FIR filter 205-1, coefficient register 208-1, a Digital-to-Analog (D/A) converter 206-1, and an amplifier 207-1. Encoder 204-1 receives and encodes digital information and provides the encoded digital information to FIR filter 205-1. FIR filter 205-1 receives coefficients from coefficient register 208-1, which FIR filter 205-1 uses in filtering and pre-distorting the encoded digital information. These coefficients may be statically or dynamically fed to FIR filter 205-1 based upon, e.g., empirical rules or bit-error checking, to modify the characteristics of the signal to permit eventual recovery of the encoded information with the least amount of error. As will be explained in further detail below, the coefficients are generated, at least in part, using coefficient calculator 213-1 of receiver 203-1. Other methods of generating coefficients may be used in conjunction with coefficient calculator 213-1. For example, the coefficients may be determined, e.g., based on prior knowledge of the channel, e.g., component location, type of media, or transmission distance. In certain complex systems, a handshake might occur with second transceiver 201-2 through impaired medium 220 to determine the best setting for the coefficients to provide to FIR filter 205-1. In some embodiments, preamplifier 209-1 might include a conventional analog filter (not shown), whereby coefficient calculator 213-1 alternatively or additionally uses signals from the conventional analog filter to generate and supply coefficients to DFE 211-1 and/or coefficient register 208-1.

FIR filter 205-1 provides the filtered, pre-distorted encoded information to D/A converter 206-1, which information D/A converter 206-1 converts to an analog signal, providing the analog signal to amplifier 207-1. Amplifier 207-1 amplifies the analog signal to permit travel of the analog signal through impaired medium 220, to be received by receiver 203-2.

In the embodiment shown, transmitter 202-2 is configured similarly to transmitter 202-1, with the amplified analog signal from amplifier 207-2 traveling through impaired medium 220 for receipt by receiver 203-1.

Receiver 203-1 includes a preamplifier 209-1, A/D converter 210-1, a decision-feedback equalizer (DFE) 211-1, coefficient calculator 213-1, and a decoder 212-1. Preamplifier 209-1 receives the analog signal from amplifier 207-2 via impaired medium 220 and provides an amplified analog signal to A/D converter 210-1, which provides a digital signal to both DFE 211-1 and coefficient calculator 213-1. In this embodiment, based on step-response characteristics (or alternatively, impulse-response or frequency-response) extrapolated or derived from the digital signal received from A/D converter 210-1, coefficient calculator 213-1 generates and provides to DFE 211-1 coefficients that DFE 211-1 uses in equalizing the digital signal.

In this embodiment, the received data is non-return-to-zero (NRZ) and approximates a step response for long run-length data, i.e., lengthened periods of a high or low state. Accordingly, A/D converter 210-1 includes a quantizer (or comparator or “slicer”) to permit digitization of the step response, so that overshoot, frequency, waveform-ringing, and other step-response characteristics may be captured either over a single event or over a period of time. Capturing this step response numerically permits the computation of a transfer function within receiver 203-1 that restores the step response to a more ideal step. This transfer function may also include known impairment differences, such as the presence (or absence) of vias, connectors, stubs, or other impairments in the transmit direction. These computed coefficients, however obtained, are used not only to set the DFE of receiver 203-1, but also to set the FIR of transmitter 202-1, as will be explained below, thereby optimizing the bit-error rate at the receiver 203-2 corresponding to transmitter 202-1.

In other embodiments, the coefficients may also be derived in other ways (not shown), just as with the coefficients for FIR filter 205-1 of transmitter 202-1. For example, the coefficients may be statically or dynamically fed to DFE 211-1 based upon, e.g., empirical rules or bit-error checking, to modify the characteristics of the signal to permit recovery of the encoded information with the least amount of error. The coefficients may be determined based on prior knowledge of the channel, e.g., component location, type of media, or transmission distance. In certain complex systems, a handshake might occur with second transceiver 201-2 through impaired medium 220 to determine the best setting for the coefficients to provide to DFE 211-1. Information during the encoding process typically includes an encoding, error-correction, and/or parity-checking scheme, such that errors may be detected in the receiver. The task of DFE 211-1 is to minimize errors, and the error check is sometimes sufficient to determine the optimum coefficients for DFE 211-1. The equalized output of DFE 211-1 is provided to decoder 212-1, which decodes the equalized output and provides decoded digital information.

In the embodiment shown, receiver 203-2 is configured similarly to receiver 203-1, with preamplifier 209-2 receiving the amplified analog signal from amplifier 207-1 of transmitter 202-1.

As mentioned above, within transceiver 201-1, transmitter 202-1 is “sideways-fed,” i.e., coefficient register 208-1 is coupled to receive coefficients for FIR filter 205-1 from coefficient calculator 213-1 of receiver 203-1, so as to create a control from receiver 203-1 to transmitter 202-1. This control permits transceiver 201-1 to use a signal received by its own receiver 203-1 to determine the response of medium 220 and to set the coefficients of its own transmitter 202-1 to compensate for the response. It is desirable that medium 220 be substantially symmetrical, i.e., that channel characteristics be substantially the same in the transmit and receive directions. It is also desirable that the characteristics of transmitter 202-2 be known, so that channel characteristics of the transmission medium can be determined independent of the characteristics of transmitter 202-2.

Conversely, within transceiver 201-2, coefficient register 208-2 is coupled to coefficient calculator 213-2, so as to create a control between transmitter 202-2 and receiver 203-2. Even if medium 220 is not symmetrical, the impairment in a transmission from transmitter 202-2 to receiver 203-1 will at least be correlated to the impairment in a transmission from transmitter 202-1 to receiver 203-2. Accordingly, transceiver 201-2 is adapted to exploit this symmetry or correlation to permit coefficients generated by coefficient calculator 213-2 based on step-response characteristics extrapolated or derived from the digital signal provided by A/D converter 210-2 to be used by coefficient register 208-2 to set the coefficients for FIR filter 205-2.

The foregoing configuration eliminates the need for a dedicated training sequence (although, in other embodiments, a training sequence could still be used in addition to the sideways-fed equalization) and further permits each of the transceivers to be self-adjusting, i.e., to have its respective transmitter and receiver function at optimal conditions independent of any channel characteristics that might be detected at the transmitter and receiver of the other transceiver.

While the embodiments herein are described with respect to wired (e.g., copper) communications, the present invention may have utility with other types of communications, including radio, electrical, and optical communications.

Although each transceiver described herein is shown as a single integrated device, each comprising a transmitter and a receiver, in other embodiments, a transceiver could alternatively comprise a separate transmitter and receiver that are co-located, i.e., at the same site or in proximity to one another, so long as there is a control or other means for providing to the transmitter channel characteristics generated by the receiver. In certain embodiments of the present invention, it is not necessary that the local transceiver transmit data to and receive data from a single remote transceiver, nor that a remote transmitter and receiver with which the local transceiver communicates be a single, integrated transceiver.

The stages or processing blocks in a transceiver (e.g., encoder, FIR filter, D/A converter, amplifier, decoder, DFE, A/D converter, and preamplifier) consistent with the present invention could be ordered in a number of different ways and are not limited to the order shown or described herein. Some stages or blocks might be omitted in various embodiments, and other stages not described herein could be added.

It should further be recognized that a system consistent with the present invention may include a control, from a local receiver to a local transmitter (i.e., either at the same site or in the same transceiver), for sharing processing parameters, step-response characteristics, transmission medium characteristics, or other data between the receiver and transmitter, without relying on a remote transceiver to generate such parameters or characteristics. It should be understood that processing parameters other than channel coefficients could alternatively or additionally be provided to the transmitter by the receiver in a system consistent with certain embodiments of the present invention. Even raw digital signal information could be provided (e.g., from A/D converter 210-1) to the transmitter by the receiver, for processing within the transmitter, in a system consistent with certain embodiments of the present invention.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer. The present invention may further be implemented as part of a simulator or electronic-design automation (EDA) tool.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. Apparatus for transmitting and receiving data via a transmission medium, the apparatus comprising:
a local receiver adapted to (1) receive an incoming data signal transmitted through the transmission medium by a remote transmitter and (2) derive from the incoming data signal one or more processing parameters corresponding to one or more characteristics of the transmission medium; and
a local transmitter adapted to (1) receive the one or more processing parameters from the local receiver; (2) generate an outgoing data signal using the one or more processing parameters; and (3) transmit the outgoing data signal through the transmission medium.

2. The apparatus of claim 1, wherein the local transmitter comprises a filter adapted to apply the one or more processing parameters as part of the generation of the outgoing data signal.

3. The apparatus of claim 1, wherein the local receiver comprises:
an analog-to-digital (A/D) converter adapted to generate a digital signal from the incoming data signal; and
a coefficient calculator adapted to generate the one or more processing parameters based on the digital signal.

4. The apparatus of claim 3, wherein the local receiver further comprises an equalizer adapted to apply the one or more processing parameters as part of processing of the incoming data signal.

5. The apparatus of claim 3, wherein the local receiver further comprises an analog filter adapted to apply the one or more processing parameters as part of processing of the incoming data signal.

6. The apparatus of claim 1, wherein at least one of the processing parameters is a transmitter coefficient.

7. The apparatus of claim 1, wherein at least one of the characteristics of the transmission medium is a step-response characteristic.

8. The apparatus of claim 1, wherein the local transmitter and local receiver are part of a single integrated device.

9. The apparatus of claim 1, wherein the local transmitter is adapted to transmit the outgoing data signal via the transmission medium to a remote receiver, wherein the remote receiver is co-located with the remote transmitter.

10. A method for transmitting and receiving data via a transmission medium, the method comprising:
(a) receiving, by a local receiver, an incoming data signal transmitted through the transmission medium by a remote transmitter;
(b) deriving, by the local receiver, from the incoming data signal one or more processing parameters corresponding to one or more characteristics of the transmission medium;
(c) transmitting the one or more processing parameters from the local receiver to a local transmitter;
(d) generating, by the local transmitter, an outgoing data signal using the one or more processing parameters; and
(e) transmitting, by the local transmitter, the outgoing data signal through the transmission medium.

11. The method of claim 10, wherein the local transmitter comprises a filter adapted to apply the one or more processing parameters as part of the generation of the outgoing data signal.

12. The method of claim 10, wherein the local receiver comprises:
an analog-to-digital (A/D) converter adapted to generate a digital signal from the incoming data signal; and
a coefficient calculator adapted to generate the one or more processing parameters based on the digital signal.

13. The method of claim 12, wherein the local receiver further comprises an equalizer adapted to apply the one or more processing parameters as part of processing of the incoming data signal.

14. The method of claim 12, wherein the local receiver further comprises an analog filter adapted to apply the one or more processing parameters as part of processing of the incoming data signal.

15. The method of claim 10, wherein at least one of the processing parameters is a transmitter coefficient.

16. The method of claim 10, wherein at least one of the characteristics of the transmission medium is a step-response characteristic.

17. The method of claim 10, wherein the local transmitter and local receiver are part of a single integrated device.

18. The method of claim 10, wherein the local transmitter is adapted to transmit the outgoing data signal via the transmission medium to a remote receiver, wherein the remote receiver is co-located with the remote transmitter.

19. Apparatus for transmitting and receiving data via a transmission medium, the apparatus comprising:
a local receiver comprising:
an analog-to-digital (A/D) converter adapted to generate a digital signal from an incoming data signal;
a coefficient calculator adapted to generate, based on the digital signal, one or more processing parameters corresponding to one or more characteristics of the transmission medium; and
a Decision-Feedback Equalizer (DFE) adapted to apply the one or more processing parameters as part of processing of the incoming data signal, the local receiver adapted to (1) receive an incoming data signal transmitted through the transmission medium by a remote transmitter and (2) derive from the incoming data signal the one or more processing parameters; and
a local transmitter comprising a Finite-Impulse Response (FIR) filter adapted to apply the one or more processing parameters as part of the generation of an outgoing data signal, the local transmitter adapted to (1) receive the one or more processing parameters from the local receiver; (2) generate the outgoing data signal using the one or more processing parameters; and (3) transmit the outgoing data signal through the transmission medium.

20. The apparatus of claim 19, wherein:
at least one of the processing parameters is a transmitter coefficient; and
at least one of the characteristics of the transmission medium is a step-response characteristic.
